(19) United States
(12) Patent Application Publication
(10) Pub. No.: US 2026/0043336 A1
(43) Pub. Date: Feb. 12, 2026

(54) POWER GENERATION SYSTEM CAPABLE OF REGULATING LOAD AND METHOD FOR ADAPTIVELY REGULATING LOAD

(71) Applicant: Nuclear Power Institute of China, Chengdu (CN)

(72) Inventors: Xiuting LIU, Chengdu (CN); Yanping HUANG, Chengdu (CN); Zhenjiang YU, Chengdu (CN); Ruilong LIU, Chengdu (CN); Yaoxing CHEN, Chengdu (CN); Houjun GONG, Chengdu (CN); Wenbin ZHUO, Chengdu (CN)

(73) Assignee: Nuclear Power Institute of China, Chengdu (CN)

(21) Appl. No.: 19/364,293

(22) Filed: Oct. 21, 2025

Related U.S. Application Data
(63) Continuation of application No. PCT/CN2024/124143, filed on Oct. 11, 2024.

(30) Foreign Application Priority Data
Apr. 1, 2024 (CN) 202410384158.7

(51) Int. Cl. F01D 15/10

(52) U.S. Cl. CPC F01D 15/10; F05D 2260/15; F05D 2270/706

(57) ABSTRACT

A power generation system capable of regulating load includes a reactor, a turbine, a recuperator, a cooler, and a compressor, the power generation working fluid returns from an outlet of the compressor to the reactor via the recuperator to form a circulation in the power generation system; a compressor bypass, connecting the outlet of the compressor and an inlet of the cooler, and provided with a first valve set; a turbine bypass, connecting an inlet and an outlet of the turbine, and provided with a second valve set; and a storage tank. An outlet of the storage tank is connected to the inlet of the cooler to form a first bypass of the storage tank provided with a third valve set. An inlet of the storage tank is connected to the outlet of the compressor to form a second bypass of the storage tank provided with a fourth valve set.

### CROSS-REFERENCE TO RELATED APPLICATIONS

The present application is a continuation application of International Application No. PCT/CN2024/124143, filed on Oct. 11, 2024, which claims priority to Chinese Patent Application No. 202410384158.7, filed with the China National Intellectual Property Administration on Apr. 1, 2024. All of the aforementioned applications are incorporated herein by reference in their entireties.

### TECHNICAL FIELD

The present application relates to the technical field, and in particular, to a power generation system capable of regulating load and a method for adaptively regulating load.

### BACKGROUND

The Brayton cycle system performs a type of thermodynamic cycle, in which the working fluid may include air, steam, and novel supercritical gaseous media (such as carbon dioxide, helium, and nitrous oxide, etc.). A supercritical carbon dioxide Brayton cycle is a novel power conversion generation system that uses supercritical carbon dioxide as the power generation working fluid, and achieves high efficiency through scientific design and optimal matching of the working fluid properties, thermodynamic processes, and system components. This system offers advantages such as high efficiency, compactness, wide applicability, and environmental friendliness, and has become one of the most promising emerging energy conversion technologies. The novel supercritical carbon dioxide power generation system is a small-scale, clean, efficient, and fast-responding closed-loop generation system. Multiple feedback loops exist within the system, and due to the drastic changes in physical properties near the critical point, the system exhibits strong nonlinearity. Its operation process is highly sensitive to changes in physical properties, making system behavior analysis and control complex. The operational modes and control methods of such a system differ significantly from those of conventional steam-based power generation systems. Therefore, it is necessary to develop new cycle structures and control methods tailored to the characteristics of the working fluid, system configuration, and application background. However, no comprehensive or systematic studies have been conducted in this field to date. Accordingly, there is a need to design and improve such cycle systems based on their specific characteristics, and to propose an all-condition load regulating method that, while ensuring system safety, improves the efficiency and response rate under partial load conditions, thereby ensuring safe, reliable, and economical operation.

### SUMMARY

The main purpose of the present application is to provide a power generation system capable of regulating load and a method for adaptively regulating load, so as to solve the problem of poor load regulation efficiency in power generation systems in the prior art.

In order to achieve the above purpose, the present application provides the following technical solutions, A power generation system capable of regulating load is provided. The power generation system includes: a reactor, a turbine, a recuperator, a cooler, and a compressor sequentially arranged such that a power generation working fluid flows through them in sequence, the power generation working fluid returning from an outlet of the compressor to the reactor via the recuperator to form a circulation in the power generation system, an output end of the turbine is connected to a generator, and the compressor, the turbine and the generator are arranged coaxially; a compressor bypass, connecting the outlet of the compressor and an inlet of the cooler, the compressor bypass being provided with a first valve set; a turbine bypass, connecting an inlet and an outlet of the turbine, the turbine bypass being provided with a second valve set; and a storage tank, an outlet of the storage tank is connected to the inlet of the cooler to form a first bypass of the storage tank, the first bypass of the storage tank being provided with a third valve set, an inlet of the storage tank is connected to the outlet of the compressor to form a second bypass of the storage tank, the second bypass of the storage tank being provided with a fourth valve set.

In an embodiment, the power generation system further includes: a first bypass of the recuperator, the first bypass of the recuperator connecting the outlet of the compressor and the inlet of the reactor, the first bypass of the recuperator being provided with a fifth valve set; and a second bypass of the recuperator, the second bypass of the recuperator connecting the outlet of the turbine and the inlet of the reactor, the second bypass of the recuperator being provided with a sixth valve set.

In an embodiment, a seventh valve set is disposed on a main connection path between the reactor and the turbine.

In an embodiment, each of the first valve set, the second valve set, the third valve set, the fourth valve set, the fifth valve set, the sixth valve set, and the seventh valve set includes a regulating valve and a shut-off valve.

In an embodiment, the power generation system further includes a proportional-integral-derivative (PID) control module, the PID control module is electrically connected to the first valve set, the second valve set, the third valve set, the fourth valve set, the fifth valve set, the sixth valve set, and the seventh valve set, and configured to send a regulation signal based on a rotational speed signal of the turbine, and a load signal of the generator, temperature, pressure, and flow rate, to control the respective valve set.

In another aspect, the present application further provides a method for adaptively regulating load. The method is applied to the foregoing power generation system, and includes: generating a regulation signal based on a difference between a target load and a current load; and controlling the first valve set to the seventh valve set according to the regulation signal to regulate a load of the power generation system.

In an embodiment, the controlling the first valve set to the seventh valve set according to the regulation signal to regulate the load of the power generation system includes: controlling the third valve set and the fourth valve set according to the regulation signal to regulate the load of the power generation system, when the current load is within a range of 90% to 100% of a full load of the power generation system; controlling the seventh valve set according to the regulation signal to regulate the load of the power generation system, when the current load is within a range of 40% to 90% of the full load of the power generation system; controlling the first valve set and the seventh valve set according to the regulation signal to regulate the load of the power generation system, when the current load is within a range of 20% to 40% of the full load of the power generation system; and controlling the first valve set and the second valve set according to the regulation signal to regulate the load of the power generation system, when the current load is within a range of 0% to 20% of the full load of the power generation system.

In an embodiment, after the controlling the first valve set to the seventh valve set according to the regulation signal to regulate the load of the power generation system, the method further includes: determining whether an inlet temperature and an outlet temperature of the reactor are both within a preset range; and regulating the inlet temperature and the outlet temperature of the reactor via the fifth valve set and the sixth valve set, if neither the inlet temperature nor the outlet temperature of the reactor is within the preset range.

In an embodiment, the controlling the first valve set and the second valve set according to the regulation signal to regulate the load of the power generation system when the current load is within the range of 0% to 20% of the full load of the power generation system includes: opening or increasing an opening degree of the second valve set according to the regulation signal, the regulation signal instructs to reduce the load; determining whether a surge occurs in the compressor; and opening or increasing an opening degree of the first valve set if determined that the surge occurs in the compressor.

In an embodiment, the controlling the first valve set and the seventh valve set according to the regulation signal to regulate the load of the power generation system when the current load is within a range of 20% to 40% of the full load of the power generation system includes: closing or decreasing an opening degree of the seventh valve set according to the regulation signal, the regulation signal instructs to reduce the load; determining whether a surge occurs in the compressor; and opening or increasing an opening degree of the first valve set if determined that the surge occurs in the compressor.

In an embodiment, the controlling the seventh valve set according to the regulation signal to regulate the load of the power generation system when the current load is within a range of 40% to 90% of the full load of the power generation system includes: decreasing an opening degree of the seventh valve set according to the regulation signal, the regulation signal instructs to reduce the load.

In an embodiment, the controlling the third valve set and the fourth valve set according to the regulation signal to regulate the load of the power generation system when the current load is within a range of 90% to 100% of the full load of the power generation system includes: closing the third valve set, and opening or increasing an opening degree of the fourth valve set according to the regulation signal, the regulation signal instructs to reduce the load.

Compared with the existing Brayton cycle power generation system, the power generation system of the present application has at least the following beneficial effects. Through the incorporation of a compressor bypass and a turbine bypass formed via branch connections, the addition of a storage tank within the system, and the establishment of bypasses between the storage tank and the compressor as well as the recuperator, the flow amount of the working fluid through each component can be controlled by means of valve sets arranged in the respective bypasses. This configuration avoids the drawbacks and limitations of relying on a single load regulating approach for the power generation system, and instead combines the characteristics of various regulating approaches to propose a load regulating approach applicable across the full operating range. The respective bypasses cooperate with one another to form an adaptive load regulating method that matches different power regulation ranges, thereby improving power generation efficiency, stabilizing system parameters, and enabling rapid load regulating.

### BRIEF DESCRIPTION OF THE DRAWINGS

FIG. 1 is a schematic structural diagram of a power generation system according to an embodiment of the present application.

FIG. 2 is a schematic flowchart of a method for adaptively regulating load according to the present application.

FIG. 3 is a schematic diagram of a control logic for regulating load by the power generation system according to the present application regulating volume.

FIG. 4 is a schematic diagram of a control logic for regulating load by the power generation system according to the present application regulating rotation speed.

FIG. 5 is a schematic diagram of a control logic for regulating load by the power generation system according to the present application via throttling control in a power generation system according to the present application.

FIG. 6 is a schematic diagram of a control logic for regulating load by the power generation system according to the present application via bypass control.

FIG. 7 is a schematic diagram of a control logic for regulating load by the power generation system according to the present application regulating temperature.

Implementations, functional features and advantages of the present disclosure will be further described with reference to the accompanying drawings in combination with the embodiments.

### DETAILED DESCRIPTION OF THE EMBODIMENTS

The technical solutions of the embodiments of the present application will be clearly and completely described below with reference to the accompanying drawings of the embodiments. It is evident that the described embodiments are only a portion of all possible embodiments of the present application, and not intended to limit the application as a whole. Based on the embodiments of the present application, all other embodiments obtained by those of ordinary skill in the art without inventive effort shall fall within the scope of protection of the present application.

The terms “first”, “second” and “third” as used in the present application are intended solely for descriptive purposes and should not be construed as indicating or implying relative importance or implicitly indicating the number of the referenced technical features. Thus, features designated with “first”, “second” or “third” may explicitly or implicitly include at least one such feature. As used in the present application, the term “plurality” means at least two, such as two, three, and so on, unless explicitly specified otherwise. All directional terms (such as up, down, left, right, front, back, etc.) used in the embodiments of the present application are intended only to illustrate the relative positional relationships or movement of the components in a particular posture (such as that shown in the accompanying drawings). Such directional indications will correspondingly change if the specified posture changes. In addition, the terms “comprise”, “include”, “have” and any variations thereof are intended to cover non-exclusive inclusions. For example, a process, method, system, product, or apparatus that includes a series of steps or elements is not limited to only those steps or elements explicitly listed, but may optionally include other steps or elements that are not listed, or may optionally include additional inherent steps or elements.

As used herein, the term “embodiment” means that a particular feature, structure, or characteristic described in connection with the embodiment may be included in at least one embodiment of the present application. The appearance of the phrase in various places throughout the specification does not necessarily refer to the same embodiment, and the described embodiments are not mutually exclusive unless otherwise specified. It will be understood by those skilled in the art that the described embodiments may be combined in whole or in part with other embodiments.

The Brayton cycle power generation system is currently a relatively mature form of thermodynamic cycle and is widely applied in the field of power generation and thermoelectric conversion. The working fluid in such a cycle may include various media such as air, steam, and supercritical gases. At present, power generation systems using supercritical carbon dioxide as the working fluid are the most prevalent. The power generation system of the present application is described and illustrated using supercritical carbon dioxide as the working fluid. However, it should be noted that this is not intended to be limiting. Any novel working fluid, whether currently known or developed in the future, that is applied to the power generation system of the present application without substantial structural modification and that achieves the same technical effects as described herein shall fall within the scope of protection sought by the present application.

In a supercritical carbon dioxide Brayton cycle system, due to the system sensitivity to the physical property variations of the working fluid near its critical point, as well as the inherent characteristics of the Brayton cycle itself, load regulation under different operating conditions remains a significant challenge.

Accordingly, a power generation system capable of regulating load is provided according to an embodiment of the present application. The power generation system includes a reactor 1, a turbine 2, a recuperator 4, a cooler 5, and a compressor 6, through which the power generation working fluid flows sequentially. The working fluid is returned from an outlet of the compressor 6 to the reactor 1 via the recuperator 4, thereby forming a circulation within the power generation system. An output end of the turbine 2 is connected to a generator 3. The compressor 6, the turbine 2, and the generator 3 are coaxially arranged. The system further includes: a compressor bypass 11, which connects the outlet of the compressor 6 to the inlet of the cooler 5 and is provided with a first valve set 21; a turbine bypass 12, which connects the inlet of the turbine 2 to the outlet of the turbine 2 and is provided with a second valve set 22; a storage tank 7; a first bypass of the storage tank 13, which connects an outlet of the storage tank 7 to the inlet of the cooler 5 and is provided with a third valve set 23; and a second bypass of the storage tank 14, which connects an inlet of the storage tank 7 to the outlet of the compressor 6 and is provided with a fourth valve set 24.

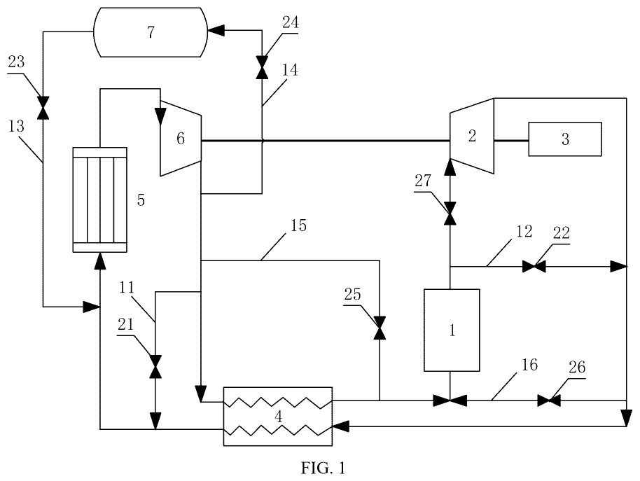

Referring to FIG. 1, in the power generation system of this embodiment, the working fluid, such as supercritical carbon dioxide, reacts and stores energy at the reactor 1, and flows through the pipeline to the turbine 2, causing the turbine 2 to perform mechanical work in rotation or other forms. The generator 3, which is coaxially connected to the turbine 2, moves along with the mechanical motion of the turbine 2 to generate electricity.

Further, the circulation loop of the power generation system is as follows. The recuperator 4 has a hot side and a cold side. The hot side inlet of the recuperator 4 is connected to the outlet of the turbine 2 to supply the working fluid circulating through the power generation system. Along the flow direction of the working fluid, the hot side outlet of the recuperator 4 is connected to the inlet of the cooler 5, the outlet of the cooler 5 is connected to the inlet of the compressor 6, and the outlet of the compressor 6 is connected to the cold side inlet of the recuperator 4. The compressor 6 and the turbine 2, along with the generator 3, are coaxially arranged to achieve synchronous rotation for work generation. The cold side outlet of the recuperator 4 is connected to the inlet of the reactor 1, thereby forming a complete closed-loop circuit.

In this embodiment, the outlet of the compressor 6 is further connected to the inlet of the cooler 5 to form the compressor bypass 11, with a first valve set 21 placed on this bypass. The inlet and outlet of the turbine 2 are connected to form a turbine bypass 12, with a second valve set 22 placed on this bypass. Referring to FIG. 1, the cooler 5 inlet and turbine 2 inlet, connected by the compressor bypass 11 and the turbine bypass 12, can respectively be equivalent to the hot side outlet of the recuperator 4 or the outlet of the reactor 1. Alternatively, the bypasses may be connected in a branch form at the corresponding positions in the circulation main path. Additionally, in this embodiment, the storage tank 7 is added, with the outlet of the storage tank 7 connected to the inlet of the cooler 5, forming a first bypass of the storage tank 13, with a third valve set 23 on this bypass. The inlet of the storage tank 7 is connected to the outlet of the compressor 6, forming a second bypass of the storage tank 14, with a fourth valve set 24 on this bypass. Thus, a power generation system capable of regulating load is formed, as provided in the present application. The load regulating methods and principles of this system will be specifically introduced in the following embodiments.

The above embodiment provides the simplest technical solution offered by the present application. With this solution, the load regulating is limited, and the effect is suboptimal. Therefore, in some embodiments, the present application further improves the above power generation system. The power generation system also includes: a seventh valve set 27 placed on the main connection path between the reactor 1 and the turbine 2.

The setting of the seventh valve set 27 enables throttling control at the inlet of the turbine 2 in the power generation system. When the opening degree of the valve in the seventh valve set 27 decreases, the pressure drop across the valve increases. On one hand, the expansion ratio and output power of the turbine 2 decrease; on the other hand, the resistance of the entire system increases, the flow rate decreases, and the compression ratio of the compressor 6 increases, resulting in an increase in the outlet pressure of the compressor 6. At this point, it is necessary to prevent the compressor 6 from entering the surge region, which requires coordination with the compressor bypass 11 in the previous embodiment to jointly regulate and increase the load reduction depth, allowing the throttling load reduction to continue.

The power generation system further includes: a first bypass 15 of the recuperator, which connects the outlet of the compressor 6 to the inlet of the reactor 1 and is provided with a fifth valve set 25; and a second bypass 16 of the recuperator, which connects the inlet of the reactor 1 to the outlet of the turbine 2 and is provided with a sixth valve set 26.

The first bypass 15 of the recuperator and the second bypass 16 of the recuperator function as follows. During the entire load regulating process, each load regulating requires determining whether the inlet and outlet temperatures of the reactor core are within the preset range. If they are not within the preset range, temperature regulating is achieved by regulating the valve opening degrees on the first bypass 15 of the recuperator and the second bypass 16 of the recuperator.

In an embodiment, each of the first valve set 21, the second valve set 22, the third valve set 23, the fourth valve set 24, the fifth valve set 25, the sixth valve set 26, and the seventh valve set 27 includes a regulating valve and a shut-off valve.

In this embodiment, by placing the seventh valve set 27 on the main connection path between the reactor 1 and the turbine 2, the speed load of the turbine 2 can be directly controlled. The first valve set 21 to the seventh valve set 27 are all configured with regulating valves and shut-off valves. The regulating valves can control the mass flow rate of the working fluid through the pipeline by regulating the opening degree, thereby achieving linear load regulation or control, while the shut-off valves are used in fully open or fully closed scenarios, facilitating adjustment operations. Additionally, with the cooperation of the various regulating valves, different circulation paths can be formed to meet the load regulating needs of the power generation system under different operating conditions.

In some embodiments, to achieve automation of the load regulating by the power generation system, the power generation system further includes a PID control module. The PID control module is electrically connected to each valve set and is configured to generate corresponding regulation signals based on the speed signal of the turbine 2, the load signal of the generator 3, temperature, pressure, and flow rate, to respectively control the opening degree and on/off state of each valve set.

The PID control module is an integrated unit module that implements the PID algorithm program. The PID control module includes at least a speed PID control submodule and a load PID control submodule, and can be applied to the power generation system of the present application, using the core control unit of the power generation system as the carrier. As a well-established existing technology, the principles and methods of implementing control are not reiterated here. The purpose of this embodiment is to indicate that by applying the PID control module to the power generation system of the present application, automated, convenient, and high-precision load control can be achieved.

In summary of the foregoing embodiments, the power generation system of the present application achieves mass control of the working fluid in the system circulation through the bypass including the compressor bypass 11, turbine bypass 12, and the storage tank 7, in a manner of splitting and merging. This, in turn, regulates the working fluid mass acting on the turbine 2 and regulates the load of the power generation system. Furthermore, by setting the first bypass 15 of the recuperator and the second bypass 16 of the recuperator, the temperature of the working fluid at the inlet and outlet of the reactor 1 can be regulated to assist in load regulation. The placement and form of the first valve set 21 to the seventh valve set 27 on each circulation main path and bypass (including shut-off valves and regulating valves) facilitate control of the power generation system's pathways and, in conjunction with the PID control module, enable the automation and efficiency of the load regulation operation.

The following provides a detailed description of the load regulation approaches and principles that the adaptive load regulation system of the present application can achieve.

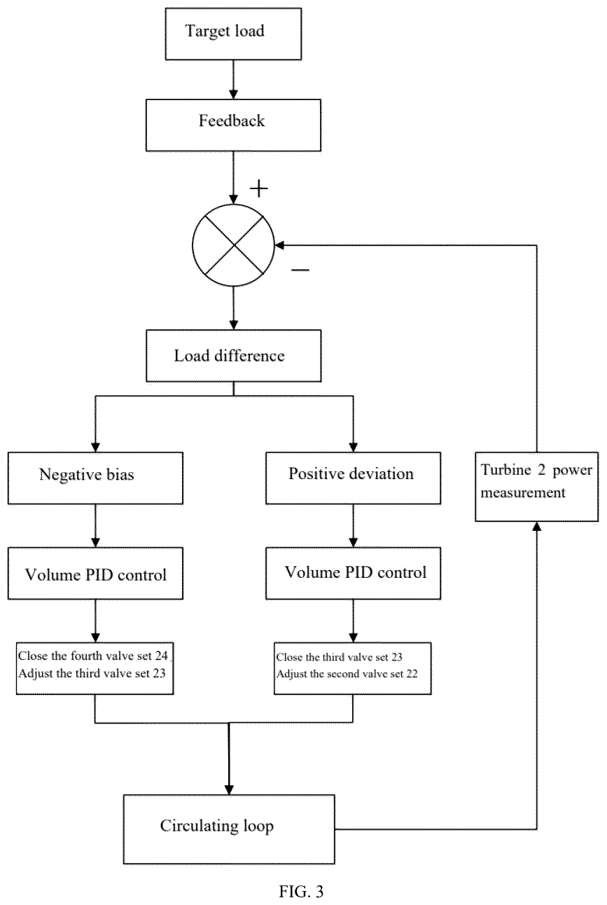

Volume regulating is first described. The working principle of volume regulating is to regulate the system load by increasing or decreasing the mass of the working fluid in the loop. The logic diagram is shown in FIG. 3. The compressor 6 in the supercritical carbon dioxide cycle operates near the critical point, where the density of the working fluid is sensitive to pressure and temperature. When the system requires load reduction, the third valve set 23 is kept closed, and the shutoff valve of the fourth valve set 24 is opened. The flow rate is regulated via the regulating valve on the pipeline, thus removing a portion of the working fluid from the loop and storing it in the storage tank 7 to achieve load reduction. When the system requires load increase, the fourth valve set 24 is kept closed, and the shutoff valve of the third valve set 23 is opened. The flow rate is regulated via the regulating valve on the pipeline, allowing the storage tank 7 to replenish some working fluid into the loop to achieve load increase. The advantage of this method is that there is no waste of working fluid energy during load variation, which helps maintain system efficiency, and the rate can be regulated fast.

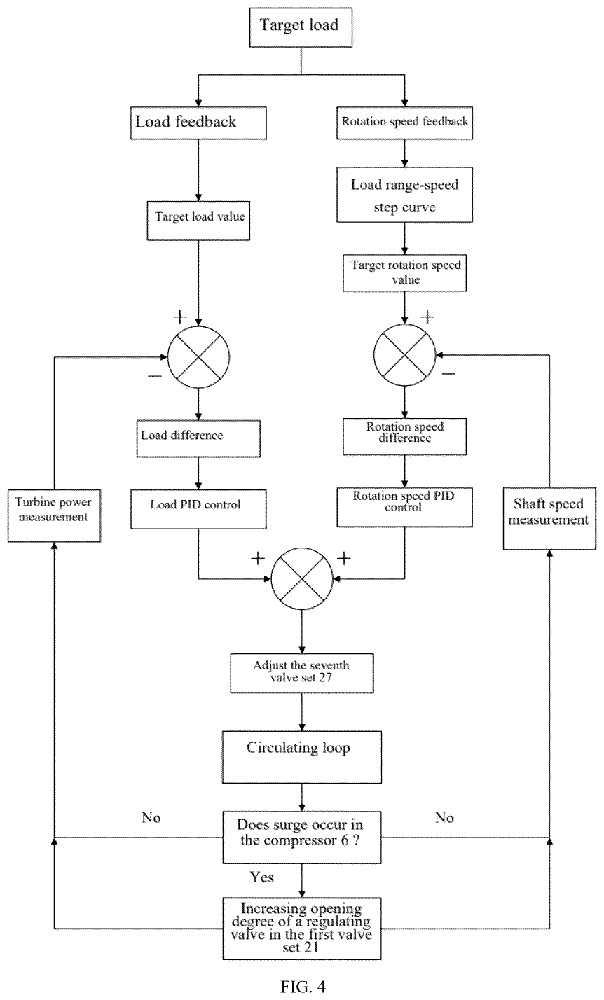

Rotational speed regulating is second described. Rotational speed regulating adjusts the system load by changing the turbine's mechanical speed, thereby altering the system flow and pressure. The logic flow diagram is shown in FIG. 4. For the coaxial layout of the compressor 6 and the turbine 2 in the cycle system, speed regulating can only result in proportional changes in the speeds of both the compressor 6 and turbine 2, i.e., the compressor 6 and turbine 2 rotate at the same speed and are regulated together. It is not possible to independently regulate the speed of the compressor and turbine. In the present application, load regulating via speed control is primarily achieved through the seventh valve set 27. Considering device lifespan and speed regulating accuracy, this control method is not suitable for applications with frequent load changes. The present application proposes a speed control method with speed step regulation based on the coaxial arrangement of the equipment. Specifically, the system operates at a constant speed within a certain load range, with secondary load regulating achieved via the seventh valve set 27. When the load exceeds this range, the speed step is changed. When the target load of the system changes and crosses the speed step corresponding to the load range, speed control is executed. At this point, both the speed feedback channel and load feedback channel are activated. On one hand, the speed feedback channel generates the target speed based on the load range-speed step curve. A speed error is generated by comparing it with the measured speed, and the speed PID control submodule produces a valve position control signal related to speed. On the other hand, the load feedback channel generates a load error by comparing the target load with the power measurement, and the load PID control submodule generates a valve position control signal related to load. These signals are then combined and applied to the seventh valve set 27 to adjust the valve, thereby switching the turbine speed step and tracking the change in target load. When performing load reduction, if the load is reduced to a certain depth, the compressor 6 may experience surge due to the reduced inlet flow. In this case, the regulating valve of the first valve set 21 of the compressor bypass 11 can be opened to increase the compressor 6 inlet flow, ensuring that the system operates stably.

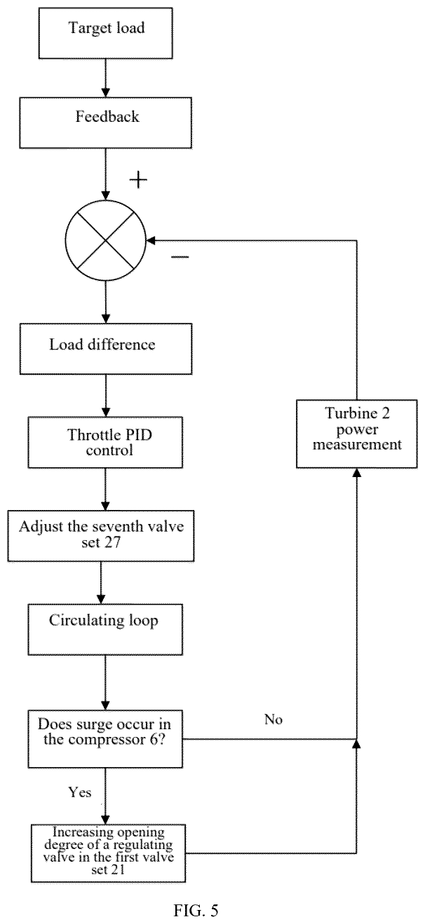

Throttle control is described third. Throttling control is a means of regulating load by altering the pressure drop in the loop. The control logic flow diagram is shown in FIG. 5. In the power generation system of the present application, throttling control is implemented at the turbine 2 inlet, specifically through the seventh valve set 27. When the opening degree of the regulating valve in the seventh valve set 27 decreases, the pressure drop across the valve increases. On one hand, the expansion ratio and output power of turbine 2 decrease; on the other hand, the resistance of the entire system increases, the flow rate decreases, and the compression ratio of the compressor 6 increases, which results in an increase in the outlet pressure of the compressor 6. At this point, it is necessary to prevent the compressor 6 from entering the surge region. This requires coordination with bypass flow control and joint regulation, increasing the depth of load reduction and allowing throttling load reduction to continue. When the system requires load reduction, the opening degree of the regulating valve in the seventh valve set 27 at the turbine 2 inlet is decreased, reducing the turbine 2 intake, thus decreasing the output power to achieve load reduction. Conversely, the opening degree of the regulating valve is increased to increase the turbine 2 intake. When the load reduction reaches a certain depth, the compressor 6 may experience surge due to reduced inlet flow. At this point, the regulating valve opening of the first valve set 21 in the compressor bypass 11 should be increased to boost the compressor 6 inlet flow, ensuring the system operates stably.

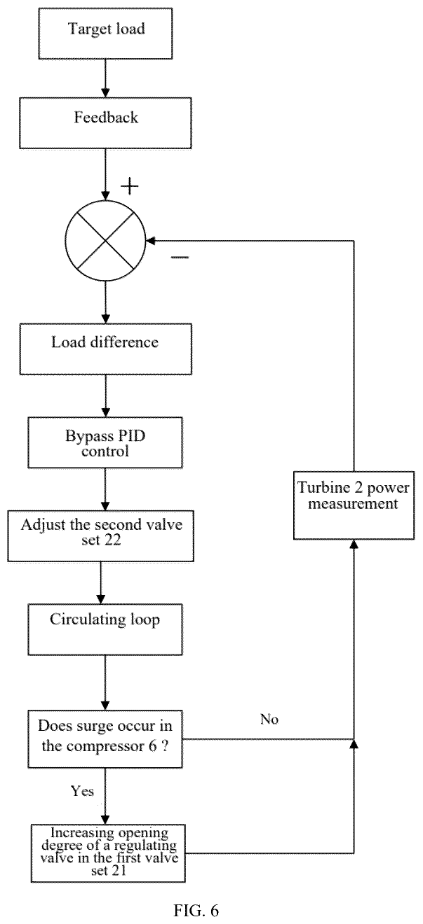

Bypass flow control is described fourth. The bypass control is a means of regulating load by changing the mass flow rate entering the compressor 6 or turbine 2. The control logic flow diagram is shown in FIG. 6. The power generation system of the present application is equipped with a compressor bypass 11 and a turbine bypass 12 to enable load regulation. When the system requires load reduction, the opening degree of the regulating valve in the second valve set 22 of the turbine bypass 12 is increased, reducing the amount of working fluid entering the turbine 2 to perform work, thereby achieving load reduction. Conversely, the opening degree of the regulating valve in the second valve set 22 of the turbine bypass 12 is decreased. When the load reduction reaches a certain depth, the compressor 6 may experience surge due to the reduced inlet flow. At this point, the regulating valve opening of the first valve set 21 in the compressor bypass 11 should be increased to boost the compressor 6 inlet flow, ensuring the system operates stably.

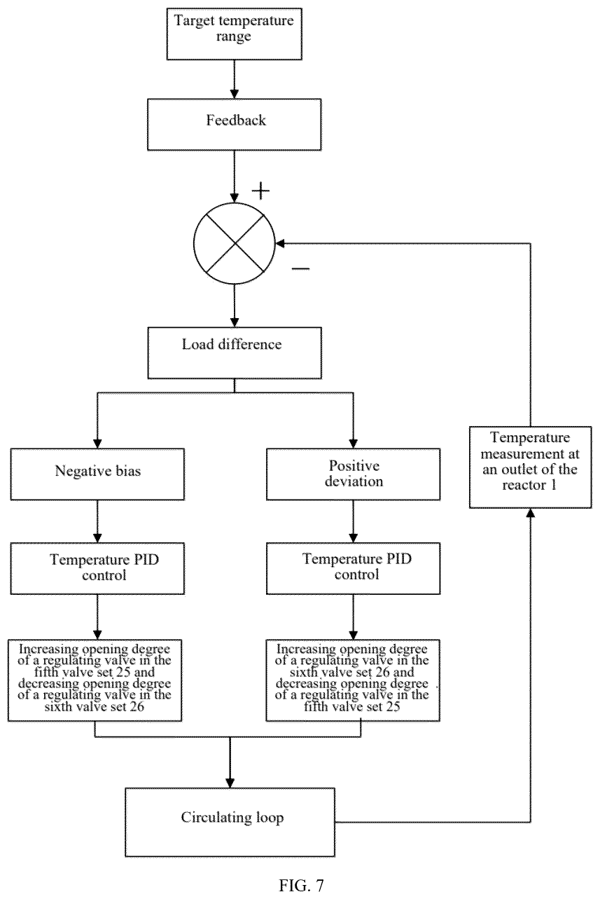

In addition, the power generation system of the present application is further provided with a first bypass 15 of the regenerator and a second bypass 16 of the regenerator, as shown in FIG. 7. By regulating the valve opening on the fifth valve set 25 and the sixth valve set 26 on the pipeline, the temperature of the working fluid at the inlet and outlet of the reactor 1 can be regulated, thereby changing the temperature of the working fluid entering the turbine 2. This, in turn, adjusts the work done by the turbine 2 and achieves load regulation. The main purpose of setting the first bypass 15 of the recuperator and the second bypass 16 of the recuperator in the power generation system is to stabilize the inlet temperature of the reactor 1, preventing large fluctuations in the reactor 1 inlet and outlet temperatures during rapid load changes, which could otherwise affect the lifespan of the reactor core materials.

Each of the load regulating methods that can be implemented by the power generation system in the present application has its own advantages, disadvantages, and limitations, and it is not possible to achieve load regulation across the entire operating range using only one method. Volume control, during its implementation, requires changes in the amount of CO₂ working fluid in the device. The wider the load regulating range, the greater the variation in the amount of CO₂ working fluid within the device, and the larger the required volume of the storage tank 7. High-pressure, large-volume storage tanks 7 involve the processing and manufacturing of large forged parts, which is not only extremely difficult but also costly. Therefore, it is suitable for use in high-load ranges with small load variations. Speed control achieves load variation with the highest efficiency throughout the entire load variation process. However, considering equipment lifespan and speed adjustment precision, this method is not suitable for scenarios involving frequent load changes. Throttling control and bypass flow control have lower adjustment efficiency and are not suitable for use in high-load ranges. They are more suitable for use during startup or in low-load ranges, where they offer the advantages of simplicity and speed.

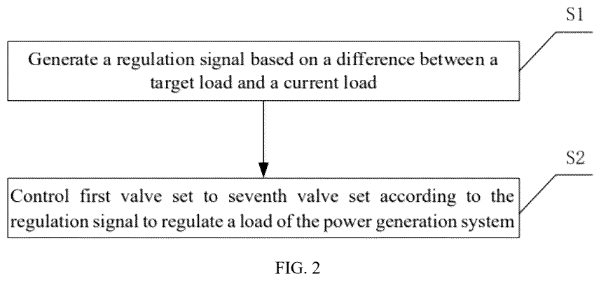

Therefore, the present application further provides a method for adaptively regulating load to integrate the various methods mentioned above for the power generation system described in the previous embodiments of the present application. As shown in FIG. 2, the method includes steps S1 to S2.

In step S1, a regulation signal is generated based on a difference between a target load and a current load.

In step S2, the first valve set 21 to the seventh valve set 27 are controlled according to the regulation signal to regulate a load of the power generation system.

Further, the controlling the first valve set 21 to the seventh valve set 27 according to the regulation signal to regulate the load of the power generation system includes: controlling the third valve set 23 and the fourth valve set 24 according to the regulation signal to regulate the load of the power generation system, when the current load is within a range of 90% to 100% of a full load of the power generation system; controlling the seventh valve set 27 according to the regulation signal to regulate the load of the power generation system, when the current load is within a range of 40% to 90% of the full load of the power generation system; controlling the first valve set 21 and the seventh valve set 27 according to the regulation signal to regulate the load of the power generation system, when the current load is within a range of 20% to 40% of the full load of the power generation system; and controlling the first valve set 21 and the second valve set 22 according to the regulation signal to regulate the load of the power generation system, when the current load is within a range of 0% to 20% of the full load of the power generation system.

Specifically, in the process of applying this method to regulate the load of the power generation system, as shown in the logical diagrams of FIG. 3 to FIG. 7, the target load is obtained, fed back to the core control section of the power generation system, and compared with the current load. After calculating the load difference, the PID control module generates the corresponding regulation signal based on the load difference. The regulation signal is expressed in a segmented, positive or negative form, and each regulation signal corresponds to controlling the opening and closing, as well as the degree of opening, of the first valve set 21 to the seventh valve set 27 to achieve comprehensive load regulation. In the load regulation across the entire operating range, for the power generation system proposed in the present application, the load regulation methods are matched with regulation segments as follows. In a range of 90% to 100% full load (including 90%), volume control is employed. In this range, fast load regulating is achieved through the storage tank 7 and its associated bypass, without the need for a large-volume storage tank. This approach facilitates overall system design optimization. In a range of 40% to 90% full load (including 40%), rotation speed control is used. This range doesn't require frequent load regulating, as the mechanical speed of the turbine 2 can be controlled. The amount of working fluid transferred between the reactor 1 and the turbine 2 is adjusted using the seventh valve set 27, allowing for stepped and secondary adjustments. This method extends device lifespan while providing efficient regulation. In a range of 20% to 40% full load (including 20%), throttling plus bypass flow control are applied. In this range, the load is low, and the required adjustment precision is higher. Load regulation is achieved by adjusting the seventh valve set 27 and the first valve set 21. When load is reduced to a certain level and compressor 6 experiences surge due to reduced inlet flow, the regulating valve of the first valve set 21 in the compressor bypass 11 is opened to increase the inlet flow, ensuring stable system operation.

Therefore, in some embodiments, the controlling the first valve set 21 and the seventh valve set 27 to regulate the load of the power generation system according to the regulation signal to regulate the load of the power generation system when the current load is within a range of 20% to 40% of the full load of the power generation system includes: closing or decreasing an opening degree of the seventh valve set 27 according to the regulation signal; determining whether a surge occurs in the compressor 6; and opening or increasing an opening degree of the first valve set 21 if determined that the surge occurs in the compressor 6.

In the range of 0% to 20% full load, the bypass flow control method is used. In this range, the power generation system operates at a very low load, requiring higher precision in load regulation. Therefore, the working fluid in the main circulation loop is regulated in small increments using the compressor bypass 11 and turbine bypass 12. Specifically, the second valve set 22 is used to regulate the load. When the load is reduced to a certain point and compressor 6 experiences surge due to decreased inlet flow, the regulating valve of the first valve set 21 in the compressor bypass 11 is opened to increase the inlet flow of the compressor, ensuring stable system operation.

In a full-load range of 0%-20%, bypass control is adopted, the load of the power generation system is in a very low state, and the precision requirement for load regulating is higher, that is, the load is regulated by means of the compressor bypass 11 and the turbine bypass 12, that is, by means of adjusting the regulating valve of the first valve set 21 of the compressor bypass 11, the inlet flow of the compressor 6 is increased by opening the regulating valve of the first valve set 21 of the compressor bypass 11, so that the system can operate normally and stably.

Therefore, in some embodiments, the controlling the first valve set 21 and the second valve set 22 according to the regulation signal to regulate the load of the power generation system when the current load is within the range of 0% to 20% of the full load of the power generation system includes: opening or increasing an opening degree of the second valve set 22 according to the regulation signal; determining whether a surge occurs in the compressor 6; and opening or increasing an opening degree of the first valve set 21 if determined that the surge occurs in the compressor 6.

In some other embodiments, after the controlling the first valve set 21 to the seventh valve set 27 according to the regulation signal to regulate the load of the power generation system, the method further includes: determining whether an inlet temperature and an outlet temperature of the reactor 1 are both within a preset range; and regulating the inlet temperature and the outlet temperature of the reactor 1 via the fifth valve set 25 and the sixth valve set 26, if neither the inlet temperature nor the outlet temperature of the reactor 1 is within the preset range.

In this embodiment, the load regulation of the power generation system is achieved by controlling the temperature through the first bypass 15 and the second bypass 16 of the heat exchanger. The PID control module can also include a temperature PID control submodule to provide temperature feedback and generate regulation signals for the power generation system's temperature under current operating conditions. This allows the temperature at the reactor 1 inlet and outlet to be regulated through the fifth valve set 25 and the sixth valve set 26.

The method for adaptively regulating load provided in the present application is applied to a power generation system capable of regulating load. It takes into full account the characteristics of the working fluid and the structure of the power generation system. This method avoids the drawbacks and limitations of using a single load regulation approach. By combining the advantages of different regulation methods, it proposes a load regulation approach that works across the entire operating range. The various bypasses cooperate with each other to form an adaptive matching regulation method based on different power ranges, thereby improving system efficiency, stabilizing system parameters, and enabling fast load regulating.

The specific embodiments of the present application are described in detail above, but are merely examples. The present application is not limited to the specific embodiments described above. For a person skilled in the art, any equivalent modification or replacement made to the application is also within the scope of the present application. Therefore, any equivalent transformation and modification, improvement, and the like made without departing from the spirit and principle of the present application shall fall within the scope of the present application.

What is claimed is:

1. A power generation system capable of regulating load, comprising:
a reactor, a turbine, a recuperator, a cooler, and a compressor sequentially arranged such that a power generation working fluid flows through them in sequence, the power generation working fluid returning from an outlet of the compressor to the reactor via the recuperator to form a circulation in the power generation system, wherein an output end of the turbine is connected to a generator, and the compressor, the turbine and the generator are arranged coaxially;
a compressor bypass, connecting the outlet of the compressor and an inlet of the cooler, and provided with a first valve set;
a turbine bypass, connecting an inlet and an outlet of the turbine, and provided with a second valve set; and
a storage tank, wherein an outlet of the storage tank is connected to the inlet of the cooler to form a first bypass of the storage tank, the first bypass of the storage tank is provided with a third valve set, an inlet of the storage tank is connected to the outlet of the compressor to form a second bypass of the storage tank, the second bypass of the storage tank is provided with a fourth valve set.

2. The power generation system capable of regulating load according to claim 1, further comprising:
a first bypass of the recuperator connecting the outlet of the compressor and the inlet of the reactor, and provided with a fifth valve set; and
a second bypass of the recuperator connecting the outlet of the turbine and the inlet of the reactor, and provided with a sixth valve set.

3. The power generation system capable of regulating load according to claim 2, wherein a seventh valve set is disposed on a main connection path between the reactor and the turbine.

4. The power generation system capable of regulating load according to claim 3, wherein each of the first valve set, the second valve set, the third valve set, the fourth valve set, the fifth valve set, the sixth valve set, and the seventh valve set comprises a regulating valve and a shut-off valve.

5. The power generation system capable of regulating load according to claim 4, further comprising:
a proportional-integral-derivative (PID) control module, electrically connected to the first valve set, the second valve set, the third valve set, the fourth valve set, the fifth valve set, the sixth valve set, and the seventh valve set, and configured to send a regulation signal based on a rotational speed signal of the turbine, and a load signal of the generator, temperature, pressure, and flow rate, to control the respective valve set.

6. A method for adaptively regulating load, applied to the power generation system capable of regulating load according to claim 1, comprising:
generating a regulation signal based on a difference between a target load and a current load; and
controlling the first valve set to the seventh valve set according to the regulation signal to regulate a load of the power generation system.

7. The method for adaptively regulating load according to claim 6, wherein the controlling the first valve set to the seventh valve set according to the regulation signal to regulate the load of the power generation system comprises:
controlling the third valve set and the fourth valve set according to the regulation signal to regulate the load of the power generation system, when the current load is within a range of 90% to 100% of a full load of the power generation system;
controlling the seventh valve set according to the regulation signal to regulate the load of the power generation system, when the current load is within a range of 40% to 90% of the full load of the power generation system;
controlling the first valve set and the seventh valve set according to the regulation signal to regulate the load of the power generation system, when the current load is within a range of 20% to 40% of the full load of the power generation system; and
controlling the first valve set and the second valve set according to the regulation signal to regulate the load of the power generation system, when the current load is within a range of 0% to 20% of the full load of the power generation system.

8. The method for adaptively regulating load according to claim 7, wherein after the controlling the first valve set to the seventh valve set according to the regulation signal to regulate the load of the power generation system, the method further comprises:
determining whether an inlet temperature and an outlet temperature of the reactor are both within a preset range; and
regulating the inlet temperature and the outlet temperature of the reactor via the fifth valve set and the sixth valve set, if neither the inlet temperature nor the outlet temperature of the reactor is within the preset range.

9. The method for adaptively regulating load according to claim 7, wherein the controlling the first valve set and the second valve set according to the regulation signal to regulate the load of the power generation system when the current load is within the range of 0% to 20% of the full load of the power generation system comprises:
opening or increasing an opening degree of the second valve set according to the regulation signal, wherein the regulation signal instructs to reduce the load;
determining whether a surge occurs in the compressor; and
opening or increasing an opening degree of the first valve set if determined that the surge occurs in the compressor.

10. The method for adaptively regulating load according to claim 7, wherein the controlling the first valve set and the seventh valve set according to the regulation signal to regulate the load of the power generation system when the current load is within a range of 20% to 40% of the full load of the power generation system comprises:
closing or decreasing an opening degree of the seventh valve set according to the regulation signal, wherein the regulation signal instructs to reduce the load;
determining whether a surge occurs in the compressor; and
opening or increasing an opening degree of the first valve set if determined that the surge occurs in the compressor.

11. The method for adaptively regulating load according to claim 7, wherein the controlling the seventh valve set according to the regulation signal to regulate the load of the power generation system when the current load is within a range of 40% to 90% of the full load of the power generation system comprises:
decreasing an opening degree of the seventh valve set according to the regulation signal, wherein the regulation signal instructs to reduce the load.

12. The method for adaptively regulating load according to claim 7, wherein the controlling the third valve set and the fourth valve set according to the regulation signal to regulate the load of the power generation system when the current load is within a range of 90% to 100% of the full load of the power generation system comprises:
closing the third valve set, and opening or increasing an opening degree of the fourth valve set according to the regulation signal, wherein the regulation signal instructs to reduce the load.
